(19) United States
(12) Patent Application Publication
(10) Pub. No.: US 2016/0165486 A1
(43) Pub. Date: Jun. 9, 2016

(54) MOBILE STATION AND MOBILE COMMUNICATION SYSTEM

(71) Applicant: NTT DOCOMO, INC., Tokyo (JP)

(72) Inventors: Tooru Uchino, Tokyo (JP); Hideaki Takahashi, Tokyo (JP)

(73) Assignee: NTT DOCOMO, INC., Tokyo (JP)

(21) Appl. No.: 14/906,572

(22) PCT Filed: Jul. 28, 2014
(86) PCT No.: PCT/JP2014/069829

§ 371 Date: Jan. 21, 2016

(30) Foreign Application Priority Data
Jul. 31, 2013 (JP) 2013-158997

(51) Int. Cl. H04W 28/08; H04W 28/02; H04W 76/02; H04L 5/00

(52) U.S. Cl. CPC H04W 28/085; H04L 5/001; H04W 28/0278; H04W 76/025

(57) ABSTRACT

The invention eliminates waste of resources attributed to transmission of a BSR in “Inter-node UP aggregation”. A mobile station (UE) of the invention includes a transmission unit (12) configured, when CA is performed by using a CC (#1) under a radio base station (eNB#1) and a CC (#2) under a radio base station (eNB#2), to send the radio base station (eNB#1) a BSR (#1) notifying a buffer residence-volume in an EPS bearer involved in the CA, and then to send the radio base station (eNB#2) a BSR (#2) notifying a buffer residence-volume other than the buffer residence-volume notified to the radio base station (eNB#1) out of a buffer residence-volume in the EPS bearer.

### TECHNICAL FIELD

The present invention relates to a mobile station and a mobile communication system.

### BACKGROUND ART

LTE (Long Term Evolution) stipulates that a mobile station UE should perform the following procedures when data to be transmitted in an uplink is generated (see Non-patent document 1).

In step 1, the mobile station UE transmits a scheduling request signal to a radio base station eNB.

As shown in FIG. 10, when the mobile station UE has a dedicated uplink resource (a PUCCH-scheduling request), the mobile station UE transmits the scheduling request signal to the radio base station eNB by using the uplink resource.

On the other hand, when the mobile station UE does not have a dedicated uplink resource, the mobile station UE executes an RA (Random Access) procedure.

In step 2, the mobile station UE transmits a BSR (Buffer Status Report) to the radio base station eNB.

As shown in FIG. 10, the mobile station UE transmits the BSR to the radio base station eNB via a PUSCH (Physical Uplink Shared Channel) corresponding to “UL grant” assigned in step 1.

Here, in the case where the RA procedure is executed, the “UL grant” is assigned to the mobile station UE by way of “RA response”.

As shown in FIG. 11, the mobile station UE is configured to use the BSR to report a total cumulative volume (a buffer residence-volume) of the data to be transmitted, for each LCG (Logical Channel Group) including an LCH (Logical Channel) where the data to be transmitted is accumulated in its buffer.

In the example of FIG. 11, the mobile station UE is configured to report the total cumulative volume of the data in the buffer not for each of LCHs #A to #D but instead for each of LCGs #0 to #2.

Meanwhile, CA (Carrier Aggregation) defined in LTE Release 10 has made it possible to achieve high throughput by performing simultaneous communication using a CC (Component Carrier) #1 and a CC #2 under the same radio base station eNB as shown in FIG. 12.

On the other hand, “Inter-node UP aggregation” to achieve high throughput by performing simultaneous communication using the CC #1 and the CC #2 under different radio base stations eNB#1 and eNB#2 as shown in FIG. 13, by extending the CA according to LTE Release 10, is under consideration in LTE Release 12 (Non-patent document 2).

For example, if a single radio base station eNB cannot accommodate all the CCs, then it is necessary to carry out the “Inter-node UP aggregation” in order to achieve throughput as high as that according to LTE Release 10.

### PRIOR ART DOCUMENTS

### Non-Patent Documents

Non-patent document 1: 3GPP TS36.321

Non-patent document 2: 3GPP TDoc R2-131782

### SUMMARY OF THE INVENTION

Nonetheless, in a current LTE method, the mobile station UE is configured to use the BSR to notify the radio base station eNB of a residence-volume of all the uplink signals stagnant at a certain point of time as the buffer residence-volume.

Accordingly, when this configuration is directly applied to the “Inter-node UP aggregation”, there is a problem that the mobile station UE may receive the “UL grant” excessively from the multiple base stations eNB, which may lead to deterioration in resource use efficiency.

For example, as shown in FIG. 14, an uplink signal residing in the mobile station UE is assumed to have a data volume of 3000 bytes . When a BSR trigger condition is met, the radio base station eNB#1 and the radio base station eNB#2 may receive the BSR of the same content, namely, the BSR notifying that the buffer residence-volume is 3000 bytes, since the mobile station UE is configured to transmit the BSR to the radio base stations eNB which assign the “UL grant” to the mobile station UE.

As a consequence, both of the radio base station eNB#1 and the radio base station eNB#2 assign the “UL grant” for 3000 bytes to the mobile station UE at the same time, and the mobile station UE will transmit the uplink signal of 3000 bytes to the radio base station eNB#1 and transmit padding of 3000 bytes to the radio base station eNB#2.

The present invention has been made in view of the above-mentioned problem. An objective of the present invention is to provide a mobile station and a mobile communication system, which are capable of eliminating waste of resources attributed to transmission of a BSR in “Inter-node UP aggregation”.

In summary, a first feature of the present invention is a mobile station including: a transmission unit configured, when carrier aggregation is performed by using a component carrier under a first radio base station and a component carrier under a second radio base station, to send the first radio base station a first buffer status report to notify a buffer residence-volume in a bearer involved in the carrier aggregation, and then to send the second radio base station a second buffer status report to notify a buffer residence-volume other than the buffer residence-volume notified to the first radio base station out of a buffer residence-volume in the bearer.

In summary, a second feature of the present invention is a mobile communication system configured to enable a mobile station to perform carrier aggregation by using a component carrier under a first radio base station and a component carrier under a second radio base station, wherein the first radio base station is provided with an RLC layer function, and a PDCP layer function as an upper layer function of the RLC layer function, the second radio base station is provided with the RLC layer function but is not provided with the PDCP layer function as the upper layer function of the RLC layer function, the mobile station is configured to transmit a control signal in an RLC layer to each of the first radio base station and the second radio base station, and the mobile station is configured not to notify the second radio base station of a buffer residence-volume of the control signal in the RLC layer in the first radio base station.

### BRIEF DESCRIPTION OF THE DRAWINGS

FIG. 1 is an overall configuration diagram of a mobile communication system according to a first embodiment of the present invention.

FIG. 2 is a functional block diagram of a mobile station UE according to the first embodiment of the present invention.

FIG. 3 is a diagram showing an example of a format of a BSR to be transmitted by the mobile station UE according to the first embodiment of the present invention.

FIG. 4 is a diagram showing an example of a format of a BSR to be transmitted by the mobile station UE according to the first embodiment of the present invention.

FIG. 5 is a diagram for explaining an operation of the mobile communication system according to the first embodiment of the present invention.

FIG. 6 is a flowchart showing an operation of the mobile station UE according to the first embodiment of the present invention.

FIG. 7 is a diagram for explaining a mobile communication system according to a first modified example of the present invention.

FIG. 8 is a flowchart showing an operation of the mobile station UE according to a first modified example of the present invention.

FIG. 9 is a diagram for explaining a mobile communication system according to a second modified example of the present invention.

FIG. 10 is a diagram for explaining the related art.

FIG. 11 is a diagram for explaining the related art.

FIG. 12 is a diagram for explaining the related art.

FIG. 13 is a diagram for explaining the related art.

FIG. 14 is a diagram for explaining the related art.

### DETAILED DESCRIPTION

### Mobile Communication System According to First Embodiment of Present Invention

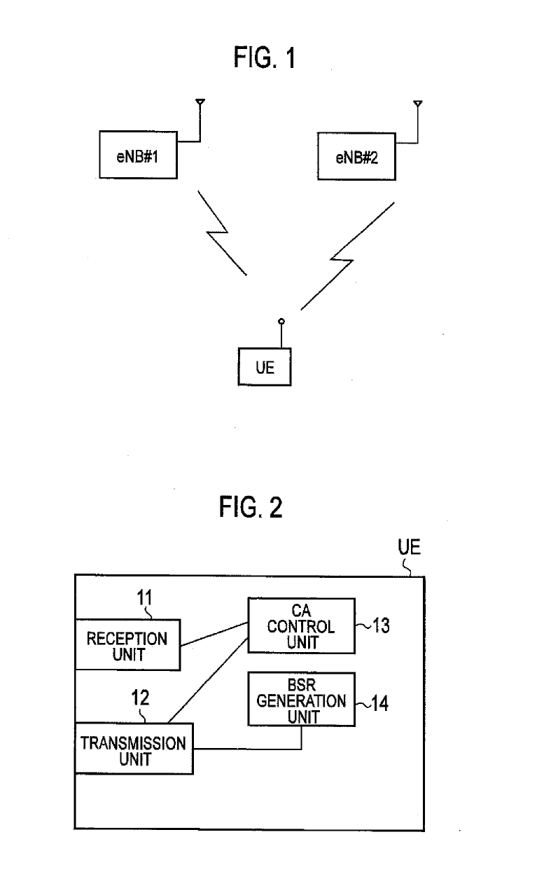

A mobile communication system according to a first embodiment of the present invention will be described with reference to FIG. 1 to FIG. 6.

As shown in FIG. 1, a mobile communication system of this embodiment is an LTE mobile communication system which includes a radio base station eNB#1, a radio base station eNB#2, and a mobile station UE.

In the mobile communication system of this embodiment, the mobile station UE is configured to be capable of performing CA by using a CC #1 under the radio base station eNB#1 and a CC #2 under the radio base station eNB#2.

In other words, the mobile communication system of this embodiment is configured to be capable of performing “Inter-node UP aggregation”.

Here, when the CA is performed, the mobile station UE is configured to perform communication by using one or more EPS (Evolved Packet System) bearers.

As shown in FIG. 2, the mobile station UE of this embodiment includes a reception unit 11, a transmission unit 12, a CA control unit 13, and a BSR generation unit 14.

The reception unit 11 is configured to receive various signals transmitted from the radio base station eNB#1 and the radio base station eNB#2, while the transmission unit 12 is configured to transmit various signals to the radio base station eNB#1 and the radio base station eNB#2.

The CA control unit 13 is configured to perform control concerning the above-mentioned CA, i.e., the “Inter-node UP aggregation” in conjunction with the reception unit 11 and the transmission unit 12.

The BSR generation unit 14 is configured to generate a BSR #1 addressed to the radio base station eNB#1 and a BSR #2 addressed to the radio base station eNB#2.

Here, concerning a buffer residence-volume (a data volume of stagnant uplink signals) in the same EPS bearer, the transmission unit 12 is configured to distinguish between a buffer residence-volume notified to the radio base station eNB#1 and a buffer residence-volume notified to the radio base station eNB#2 when the above-mentioned CA is performed.

For example, in the case where the above-mentioned CA is performed, the transmission unit 12 is configured, when an uplink signal of 1000 bytes is generated as an uplink signal to be transmitted in the EPS bearer involved in the CA, to send the radio base station eNB#1 the BSR #1 for notifying a buffer residence-volume (1000 bytes), and then when an uplink signal of 500 bytes is further generated as an uplink signal to be transmitted in the EPS bearer involved in the CA, to send the radio base station eNB#2 the BSR #2 for notifying a buffer residence-volume (500 bytes) other than the buffer residence-volume (1000 bytes) notified to the radio base station eNB#1, out of the buffer residence-volume (1500 bytes) in the EPS bearer.

Meanwhile, in order that the CC (a cell) under the radio base station eNB#2 (or the radio base station eNB#1) can promptly allocate an uplink resource when allocation of an uplink resource by the CC (a cell) under the radio base station eNB#1 (or the radio base station eNB#2) is disabled due to a reason such as deterioration in radio quality, the transmission unit 12 may be configured to notify the radio base station eNB#1 (or the radio base station eNB#2) of the buffer residence-volume notified to the radio base station eNB other than the radio base station eNB#1 (or the radio base station eNB#2) by using the BSR #1 (or the BSR #2).

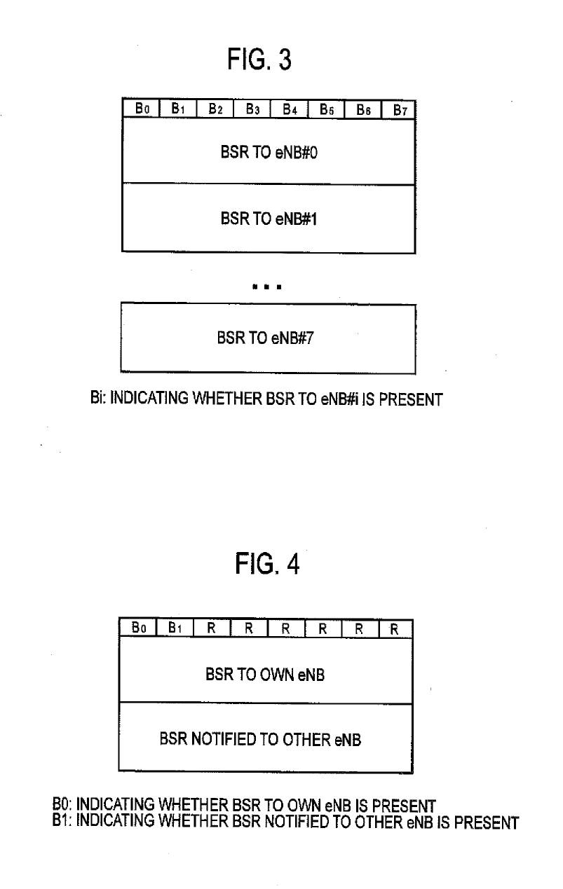

Here, as shown in FIG. 3, the BSR #1 (or the BSR #2) may be designed to use bits from B0 to B7 in order to indicate to which radio base station eNB the above-mentioned buffer residence-volume is notified.

Alternatively, as shown in FIG. 4, the BSR #1 and the BSR #2 may be designed to use one bit in order to simply indicate whether or not the above-mentioned buffer residence-volume is notified to a different radio base station eNB.

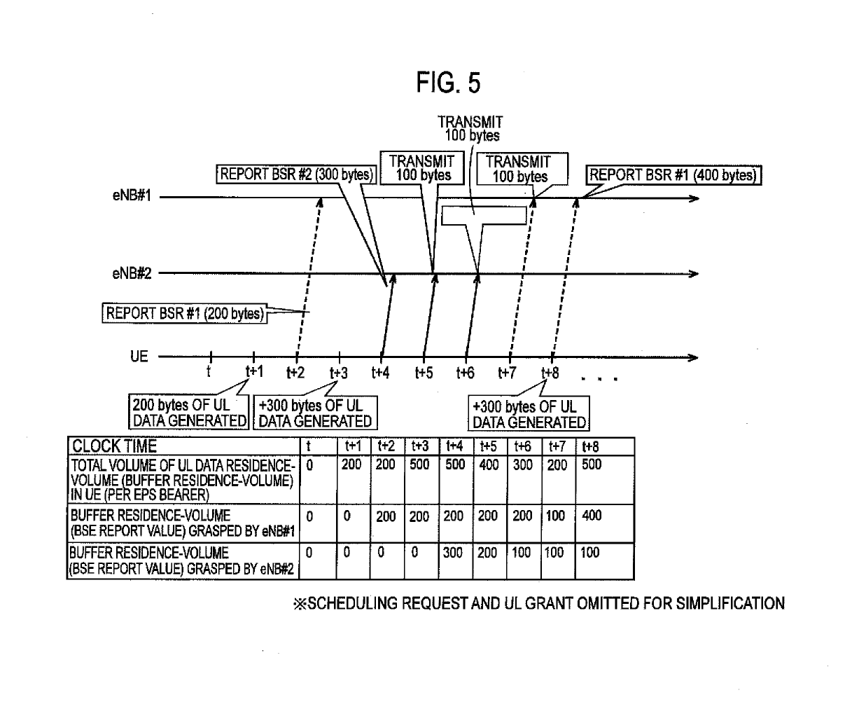

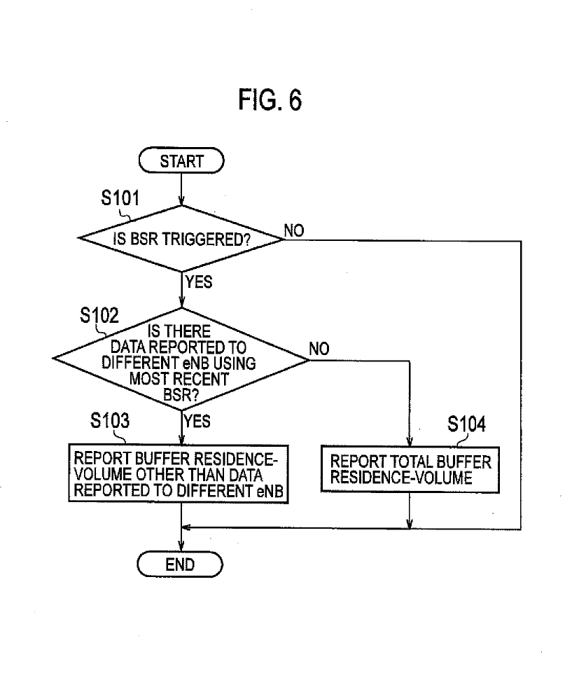

Operations of the mobile communication system of this embodiment will be described below with reference to FIG. 5 and FIG. 6.

First, an operation by the mobile station UE to transmit the BSR when the “Inter-node UP aggregation” is performed in the mobile communication system of this embodiment will be described with reference to FIG. 5.

In the following description, the “Inter-node UP aggregation” is assumed to involve one EPS bearer for the sake of convenience.

As shown in FIG. 5, at clock time t, a buffer residence-volume (a total volume) in the EPS bearer involved in the “Inter-node UP aggregation” is 0 byte while a buffer residence-volume (in the aforementioned EPS bearer) grasped by each of the radio base station eNB#1 and the radio base station eNB#2 is also 0 byte.

When an uplink signal (UL data) of 200 bytes to be transmitted in the EPS bearer involved in the “Inter-node UP aggregation” is generated at clock time t+1, the mobile station UE sends the radio base station eNB#1 the BSR #1 at clock time t+2, notifying that the buffer residence-volume is 200 bytes.

As a result, the buffer residence-volume (in the aforementioned EPS bearer) grasped by the radio base station eNB#1 at the clock time t+2 is 200 bytes. Here, the buffer residence-volume (the total volume) in the aforementioned EPS bearer is equal to 200 bytes.

When an uplink signal (UL data) of 300 bytes to be transmitted in the EPS bearer is generated at clock time t+3, the mobile station UE sends the radio base station eNB#2 the BSR #2 at clock time t+4, notifying that the buffer residence-volume is 300 bytes.

As a result, the buffer residence-volume (in the aforementioned EPS bearer) grasped by the radio base station eNB#2 at the clock time t+4 is 300 bytes. Here, the buffer residence-volume (the total volume) in the aforementioned EPS bearer is equal to 500 bytes.

In response to “UL grant” from the radio base station eNB#2, the mobile station UE sends the radio base station eNB#2 an uplink signal (UL data) of 100 bytes at clock time t+5, and sends the radio base station eNB#2 an uplink signal (UL data) of 100 bytes at clock time t+6.

As a result, the buffer residence-volume (in the aforementioned EPS bearer) grasped by the radio base station eNB#2 at the clock time t+6 is 100 bytes. Here, the buffer residence-volume (the total volume) in the aforementioned EPS bearer is equal to 300 bytes.

In response to “UL grant” from the radio base station eNB#1, the mobile station UE sends the radio base station eNB#1 an uplink signal (UL data) of 100 bytes at clock time t+7.

As a result, the buffer residence-volume (in the aforementioned EPS bearer) grasped by the radio base station eNB#1 at the clock time t+7 is 100 bytes. Here, the buffer residence-volume (the total volume) in the aforementioned EPS bearer is equal to 200 bytes.

When an uplink signal (UL data) of 300 bytes to be transmitted in the EPS bearer is generated at clock time t+8, the mobile station UE sends the radio base station eNB#1 the BSR #1 at clock time t+8, notifying that the buffer residence-volume is 400 bytes.

As a result, the buffer residence-volume (in the aforementioned EPS bearer) grasped by the radio base station eNB#1 at the clock time t+8 is 400 bytes. Here, the buffer residence-volume (the total volume) in the aforementioned EPS bearer is equal to 500 bytes.

Second, an operation of the mobile station UE of this embodiment will be described with reference to FIG. 6.

As shown in FIG. 6, in step S101, the mobile station UE determines whether or not a BSR is triggered, i.e., whether or not a BSR trigger condition is met.

The operation proceeds to step S102 in the case of “Yes”, or the operation is terminated in the case of “No”.

In step S102, the mobile station UE determines whether or not there is the buffer residence-volume notified to a different radio base station eNB by using the BSR.

The operation proceeds to step S103 in the case of “Yes”, or the operation proceeds to step S104 in the case of “No”.

In step S103, the mobile station UE uses the BSR to notify the buffer residence-volume other than the buffer residence-volume notified to the different radio base station eNB.

Meanwhile, in step S104, the mobile station UE uses the BSR to notify the total buffer residence-volume.

### First Modified Example

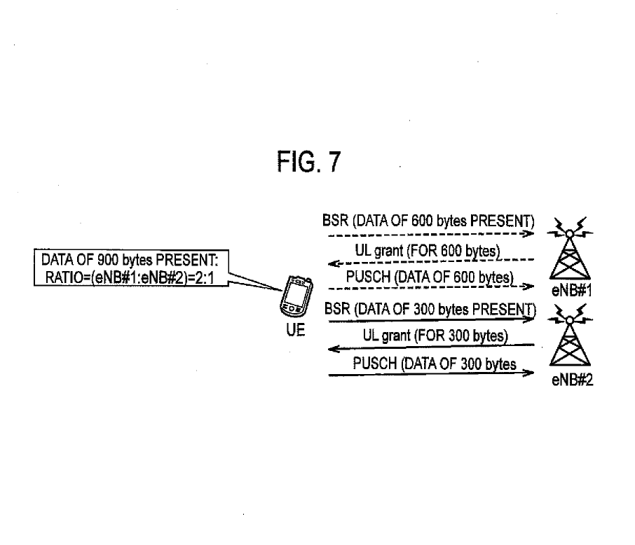

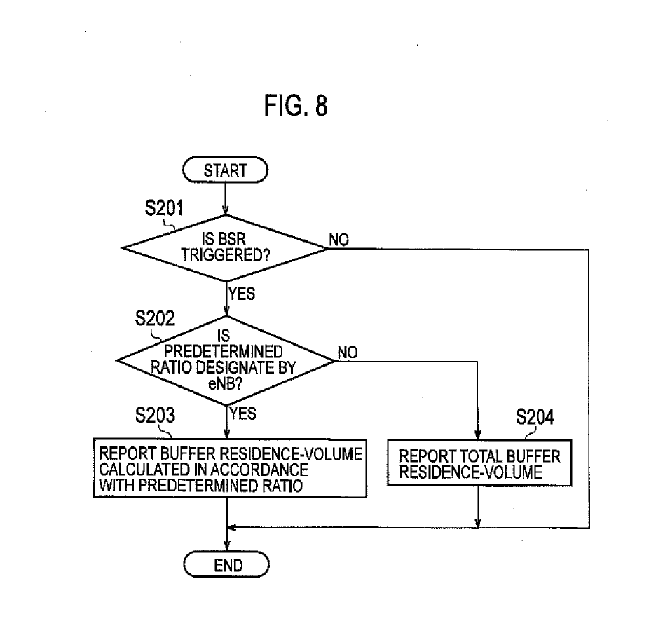

A mobile communication system according to a first modified example of the present invention will be described below with reference to FIG. 7 and FIG. 8 while focusing on different features from those of the mobile communication system according to the above-mentioned first embodiment.

In the mobile communication system according to the first modified example, the transmission unit 12 of the mobile station UE is configured to determine the buffer residence-volume to be notified by using the BSR #1 and the buffer residence-volume to be notified by using the BSR #2 out of the buffer residence-volume in the EPS bearer described above, on the basis of a predetermined ratio.

For example, in the case where the predetermined ratio is defined as (radio base station eNB#1 to radio base station eNB#2)=2 to 1 as shown in FIG. 7, the transmission unit 12 of the mobile station UE is configured, when an uplink signal of 900 bytes is generated as the uplink signal to be transmitted in the EPS bearer inside the mobile station UE, to send the radio base station eNB#1 the BSR #1 notifying that the buffer residence-volume is 600 bytes and to send the radio base station eNB#2 the BSR #2 notifying that the buffer residence-volume is 300 bytes.

Here, the predetermined ratio may be designated by a network such as a radio base station eNB and a mobility management node MME.

Such designation may be performed by using an RRC (Radio Resource Control) layer or a MAC (Media Access Control) layer.

Meanwhile, the radio base station eNB may allocate the resource for transmitting the uplink signal by using the predetermined ratio.

In addition, the above-mentioned predetermined ratio may be designed to be determined on the basis of at least one of average data rates (or average throughputs) in the uplinks in the radio base station eNB#1 and the radio base station eNB#2, allocation ratios of resources of the uplinks to the mobile station UE, and radio quality (such as CQI) in the uplinks. In other words, the predetermined ratio may be designed to be updated as needed.

For example, the above-mentioned predetermined ratio may be designed such that a radio base station eNB with a faster average data rate mentioned above or a radio base station eNB with better radio quality is granted a higher proportion.

Meanwhile, the above-mentioned predetermined ratio may be designed to be reset when at least one of a connection re-establishment procedure, an Scell (Secondary Cell) deletion procedure, and an RA procedure takes place.

An operation of the mobile station UE of this modified example will be described below with reference to FIG. 8.

As shown in FIG. 8, in step S201, the mobile station UE determines whether or not the BSR is triggered, i.e., whether or not the BSR trigger condition is met.

The operation proceeds to step S202 in the case of “Yes”, or the operation is terminated in the case of “No”.

In step S202, the mobile station UE determines whether or not the above-mentioned predetermined ratio is designated by the network.

The operation proceeds to step S203 in the case of “Yes”, or the operation proceeds to step S204 in the case of “No”.

In step S203, the mobile station UE sends the radio base station eNB the BSR notifying the buffer residence-volume calculated in accordance with the predetermined ratio.

Meanwhile, in step S204, the mobile station UE uses the BSR to notify the total buffer residence-volume.

### Second Modified Example

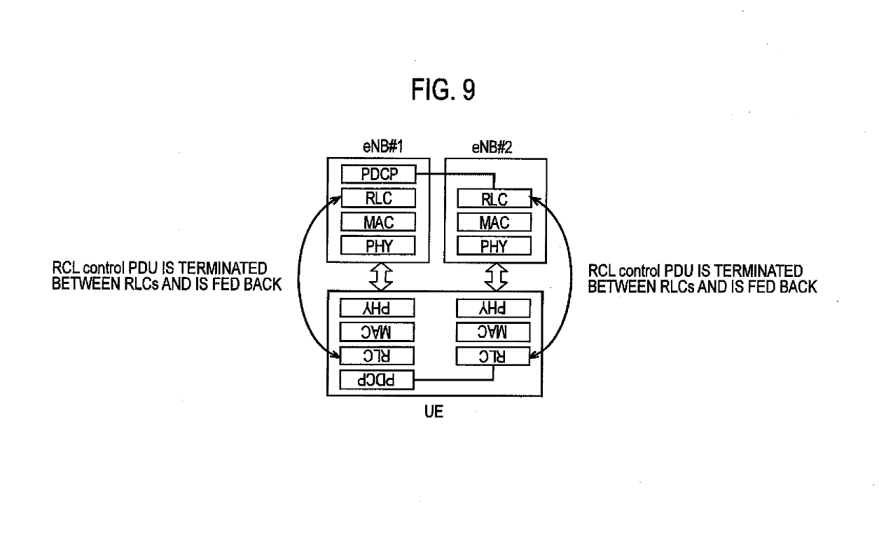

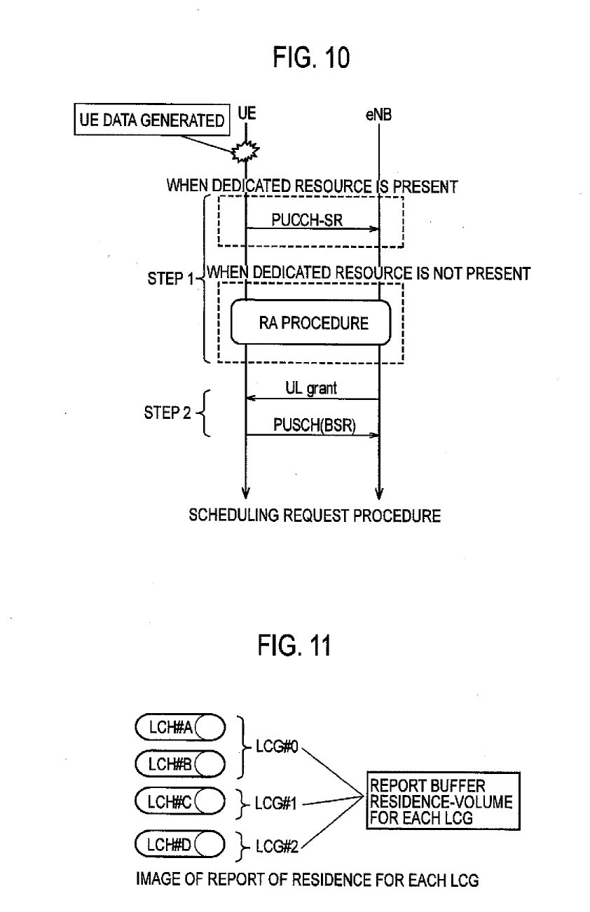

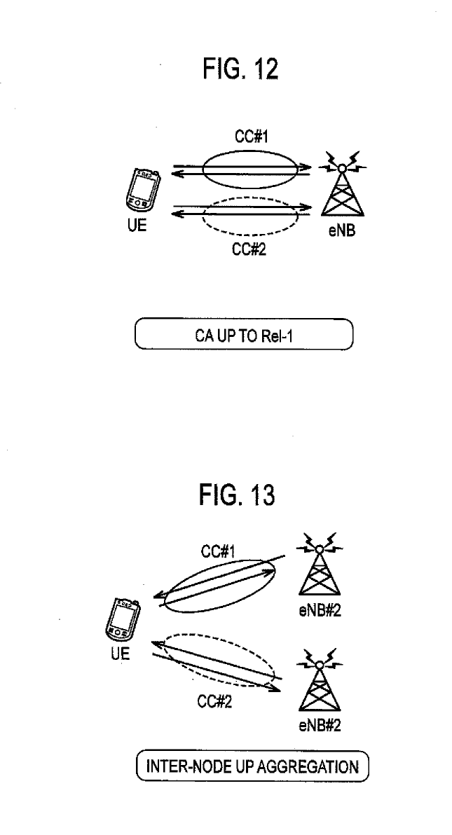

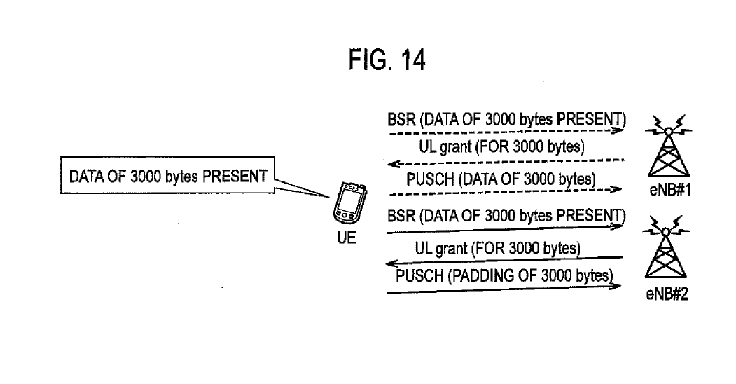

A mobile communication system according to a second modified example of the present invention will be described below with reference to FIG. 9 while focusing on different features from those of the mobile communication system according to the first embodiment and the first modified example mentioned above.

As shown in FIG. 9, the radio base station eNB#1 is provided with a physical (PHY) layer function, a MAC layer function as an upper layer function of the physical layer function, an RLC (Radio Link Control) layer function as an upper layer function of the MAC layer function, and a PDCP (Packet Data Convergence Protocol) layer function as an upper layer function of the RLC layer function.

On the other hand, the radio base station eNB#2 is provided with the physical (PHY) layer function, the MAC layer function as the upper layer function of the physical layer function, and the RLC layer function as the upper layer function of the MAC layer function. However, the radio base station eNB#2 is not provided with the PDCP layer function as the upper layer function of the RLC layer function.

In the above-described protocol stack, since the RLC layer function is terminated at each radio base station eNB#1/eNB#2, “control PDU (Packet Data Unit)” in the RLC layer such as “RLC status report” needs to be fed back to each radio base station eNB#1/eNB#2.

Accordingly, the mobile station UE is configured to transmit the “control PDU” in the RLC layer to each of the radio base station eNB#1 and the radio base station eNB#2.

In this case, the mobile station UE is configured not to notify the radio base station eNB#2 of a buffer residence-volume of the “control PDU” in the RLC layer in the mobile station UE corresponding to the RLC layer terminated at the radio base station eNB#1.

The foregoing feature of the present embodiment may be expressed as follows.

In summary, a first feature of the present embodiment is a mobile station UE including: a transmission unit 12 configured, when CA is performed by using a CC #1 under a radio base station eNB#1 (first radio base station) and a CC #2 under a radio base station eNB#2 (second radio base station), to send the radio base station eNB#1 a BSR #1 (first buffer status report) to notify a buffer residence-volume in an EPS bearer involved in the CA, and then to send the radio base station eNB#2 a BSR #2 (second buffer status report) to notify a buffer residence-volume other than the buffer residence-volume notified to the radio base station eNB#1 out of a buffer residence-volume in the EPS bearer.

According to the above-described feature, it is possible to avoid a situation in which both of the radio base station eNB#1 and the radio base station eNB#2 receive the BSR of the same content, and thus to eliminate waste of resources attributed to transmission of the BSR in the “Inter-node UP aggregation”.

In the first feature of the present embodiment, the transmission unit 12 may be configured to use the BSR #2 to notify the radio base station eNB#2 of a buffer residence-volume notified to a radio base station other than the radio base station eNB#2.

According to the above-described feature, the CC (the cell) under the radio base station eNB#2 can promptly allocate the uplink resource when allocation of the uplink resource by the CC (the cell) under the radio base station eNB#1 is disabled due to a reason such as deterioration in radio quality.

In the first feature of the present embodiment, the transmission unit 12 may be configured to use the BSR #2 to notify the radio base station eNB#2 of a buffer residence-volume notified to the radio base station eNB#1.

According to the above-described feature, when the “Inter-node UP aggregation” is performed while involving the multiple radio base stations eNB, the radio base station eNB#2 can grasp the buffer residence-volume notified to each radio base station eNB (the radio base station eNB#1).

In the first feature of the present embodiment, the transmission unit 12 may be configured to determine a buffer residence-volume to be notified by using the BSR #1 and a buffer residence-volume to be notified by using the BSR #2 out of the buffer residence-volume in the foregoing EPS bearer, on the basis of a predetermined ratio.

According to the above-described feature, the mobile station UE is configured to determine the buffer residence-volume to be notified to each radio base station eNB#1/eNB#2 based on the predetermined ratio. Thus, it is possible to allocate the uplink resource flexibly depending on various circumstances.

In the first feature of the present embodiment, the predetermined ratio may be determined on the basis of at least one of average data rates in uplinks in the radio base station eNB#1 and the radio base station eNB#2, allocation ratios of resources of the uplinks to the mobile station UE, and radio quality in the uplinks.

According to the above-described feature, it is possible to update the above-mentioned predetermined ratio with an appropriate value as needed depending on a communication circumstance.

In the first feature of the present embodiment, the predetermined ratio may be reset when at least one of a connection re-establishment procedure, an Scell (secondary cell) deletion procedure, and an RA procedure (random access procedure) takes place.

According to the above-described feature, it is possible to reset the above-mentioned predetermined ratio and to set the ratio to an appropriate value again at the time of starting communication, detection of an anomaly, or the like.

In summary, a second feature of the present embodiment is a mobile communication system configured to enable a mobile station UE to perform CA by using a CC #1 under a radio base station eNB#1 and a CC #2 under a radio base station eNB#2, wherein the radio base station eNB#1 is provided with an RLC layer function, and a PDCP layer function as an upper layer function of the RLC layer function, the radio base station eNB#2 is provided with the RLC layer function but is not provided with the PDCP layer function as the upper layer function of the RLC layer function, the mobile station UE is configured to transmit a “control PDU (control signal)” in an RLC layer to each of the radio base station eNB#1 and the radio base station eNB#2, and the mobile station UE is configured not to notify the radio base station eNB#2 of a buffer residence-volume of the “control PDU” in the RLC layer in the radio base station eNB#1.

According to the above-described feature, in the above-mentioned protocol stack, the mobile station UE is configured to invariably transmit the “control PDU” in the RLC layer terminated at the radio base station eNB#1 to the radio base station eNB#1. Thus, it is possible to reduce a load associated with an action to notify the radio base station eNB#2 of the buffer residence-volume of the “control PDU”.

It should be noted that the foregoing operations of the mobile station UE and the radio base stations eNB#1/eNB#2 may be implemented by hardware, may be implemented by a software module executed by a processor, or may be implemented in combination of the two.

The software module may be provided in a storage medium in any format, such as a RAM (Random Access Memory), a flash memory, a ROM (Read Only Memory), an EPROM (Erasable Programmable ROM), an EEPROM (Electronically Erasable and Programmable ROM), a register, a hard disk, a removable disk, or a CD-ROM.

The storage medium is connected to a processor so that the processor can read and write information from and to the storage medium. Instead, the storage medium may be integrated in a processor. The storage medium and the processor may be provided inside an ASIC. Such an ASIC may be provided in the mobile station UE or the radio base station eNB#1/eNB#2. Otherwise, the storage medium and the processor maybe provided as discrete components inside the mobile station UE or the radio base station eNB#1/eNB#2.

Hereinabove, the present invention has been described in detail by use of the foregoing embodiments. However, it is apparent to those skilled in the art that the present invention should not be limited to the embodiments described in the specification. The present invention can be implemented as an altered or modified embodiment without departing from the spirit and scope of the present invention, which are determined by the description of the scope of claims. Therefore, the description of the specification is intended for illustrative explanation only and does not impose any limited interpretation on the present invention.

Note that the entire content of Japanese Patent Application No. 2013-158997 (filed on Jul. 31, 2013) is incorporated by reference in the present specification.

### INDUSTRIAL APPLICABILITY

As described above, according to the present invention, it is possible to provide a mobile station and a mobile communication system, which are capable of eliminating waste of resources attributed to transmission of a BSR in “Inter-node UP aggregation”.

### EXPLANATION OF THE REFERENCE NUMERALS

eNB#1, eNE#2 radio base station

UE mobile station

11 reception unit

12 transmission unit

13 CA control unit

14 BSR generation unit

1. A mobile station comprising:
a transmission unit configured, when carrier aggregation is performed by using a component carrier under a first radio base station and a component carrier under a second radio base station, to send the first radio base station a first buffer status report to notify a buffer residence-volume in a bearer involved in the carrier aggregation, and then to send the second radio base station a second buffer status report to notify a buffer residence-volume other than the buffer residence-volume notified to the first radio base station out of a buffer residence-volume in the bearer.

2. The mobile station according to claim 1, wherein the transmission unit is configured to use the second buffer status report to notify the second radio base station of the buffer residence-volume notified to a radio base station other than the second radio base station.

3. The mobile station according to claim 1, wherein the transmission unit is configured to use the second buffer status report to notify the second radio base station of the buffer residence-volume notified to the first radio base station.

4. The mobile station according to claim 1, wherein the transmission unit is configured to determine a buffer residence-volume to be notified by using the first buffer status report and a buffer residence-volume to be notified by using the second buffer status report out of the buffer residence-volume in the bearer, on the basis of a predetermined ratio.

5. The mobile station according to claim 4, wherein the predetermined ratio is designed to be determined on the basis of at least one of average data rates in uplinks in the first radio base station and the second radio base station, allocation ratios of resources of the uplinks to the mobile station, and radio quality in the uplinks.

6. The mobile station according to claim 4, wherein the predetermined ratio is designed to be reset when at least one of a connection re-establishment procedure, a secondary cell deletion procedure, and a random access procedure takes place.

7. A mobile communication system configured to enable a mobile station to perform carrier aggregation by using a component carrier under a first radio base station and a component carrier under a second radio base station, wherein
the first radio base station is provided with an RLC layer function, and a PDCP layer function as an upper layer function of the RLC layer function,
the second radio base station is provided with the RLC layer function but is not provided with the PDCP layer function as the upper layer function of the RLC layer function,
the mobile station is configured to transmit a control signal in an RLC layer to each of the first radio base station and the second radio base station, and
the mobile station is configured not to notify the second radio base station of a buffer residence-volume of the control signal in the RLC layer in the first radio base station.
